(19) United States
(12) Patent Application Publication
(10) Pub. No.: US 2026/0058381 A1
(43) Pub. Date: Feb. 26, 2026

(54) ELECTRICAL CONNECTOR AND ASSEMBLY

(71) Applicant: Lear Corporation, Southfield, MI (US)

(72) Inventors: Jun Roz Ruayana, Cebu City (PH); Vinodh Krishnan Balasubramanian, Sterling Heights, MI (US); John Montgomery, Canton, MI (US); William Bond, Livonia, MI (US); Erwin Baga-an, Cebu City (PH); Gaie Annah Marie Torrecampo Arzadon, Cebu City (PH)

(73) Assignee: Lear Corporation, Southfield, MI (US)

(21) Appl. No.: 18/812,938

(22) Filed: Aug. 22, 2024

(51) Int. Cl. H01R 9/24; H01R 9/22

(52) U.S. Cl. CPC H01R 9/2491; H01R 9/223

(57) ABSTRACT

An electrical connector, comprising: a housing at least partially defining a plurality of terminal channels configured to at least partially receive a plurality of electrical terminals; a cover releasably connected to the housing; and a plurality of first terminal connectors connected to the cover and each disposed partially in or adjacent to two terminal channels of the plurality of terminal channels to electrically connect a respective two electrical terminals of the plurality of electrical terminals.

### TECHNICAL FIELD

The present disclosure generally relates to electrical connectors and assemblies, including electrical connectors and assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is an exploded perspective view generally illustrating an embodiment of an electrical assembly according to teachings of the present disclosure.

FIGS. 2 and 3 are perspective views generally illustrating an embodiment of a housing of an electrical assembly according to teachings of the present disclosure.

FIG. 4 is a perspective view generally illustrating an embodiment of a cover of an electrical assembly according to teachings of the present disclosure.

FIG. 5 is a perspective view generally illustrating an embodiment of a first terminal connector of an electrical assembly according to teachings of the present disclosure.

FIG. 6 is a perspective view generally illustrating an embodiment of a second terminal connector of an electrical assembly according to teachings of the present disclosure.

FIG. 7 is a perspective view generally illustrating portions of an embodiment of an electrical assembly according to teachings of the present disclosure.

FIG. 8 is a cross-sectional view generally illustrating portions of an embodiment of an electrical assembly according to teachings of the present disclosure.

FIG. 9 is a perspective view generally illustrating an assembled configuration of an embodiment of an electrical assembly according to teachings of the present disclosure.

FIG. 10 is an exploded perspective view generally illustrating an embodiment of an electrical assembly according to teachings of the present disclosure.

FIG. 11 is a perspective view generally illustrating an embodiment of a housing of an electrical assembly according to teachings of the present disclosure.

FIG. 12 is a perspective view generally illustrating an embodiment of a cover of an electrical assembly according to teachings of the present disclosure.

FIG. 13 is a perspective view generally illustrating an embodiment of a second terminal connector of an electrical assembly according to teachings of the present disclosure.

FIG. 14 is a perspective view generally illustrating portions of an embodiment of an electrical assembly according to teachings of the present disclosure.

FIG. 15 is a perspective view generally illustrating an assembled configuration of an embodiment of an electrical assembly according to teachings of the present disclosure.

FIG. 16 is an exploded perspective view generally illustrating an embodiment of an electrical assembly according to teachings of the present disclosure.

FIG. 17 is a perspective view generally illustrating an embodiment of a housing of an electrical assembly according to teachings of the present disclosure.

FIG. 18 is a perspective view generally illustrating an embodiment of a cover of an electrical assembly according to teachings of the present disclosure.

FIG. 19 is a perspective view generally illustrating portions of an embodiment of an electrical assembly according to teachings of the present disclosure.

FIG. 20 is a perspective view generally illustrating an assembled configuration of an embodiment of an electrical assembly according to teachings of the present disclosure.

FIG. 21 is a cross-sectional view generally illustrating portions of an embodiment of an electrical assembly according to teachings of the present disclosure.

FIGS. 22A-22H are ends views generally illustrating portions of embodiment of electrical assemblies provide a plurality of splice configurations according to teachings of the present disclosure.

FIG. 23 is a perspective view generally illustrating assembled configurations of an embodiment of an electrical assembly including two stacked connectors according to teachings of the present disclosure.

FIG. 24 is a flow diagram generally illustrating an embodiment of a method of assembling an electrical assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

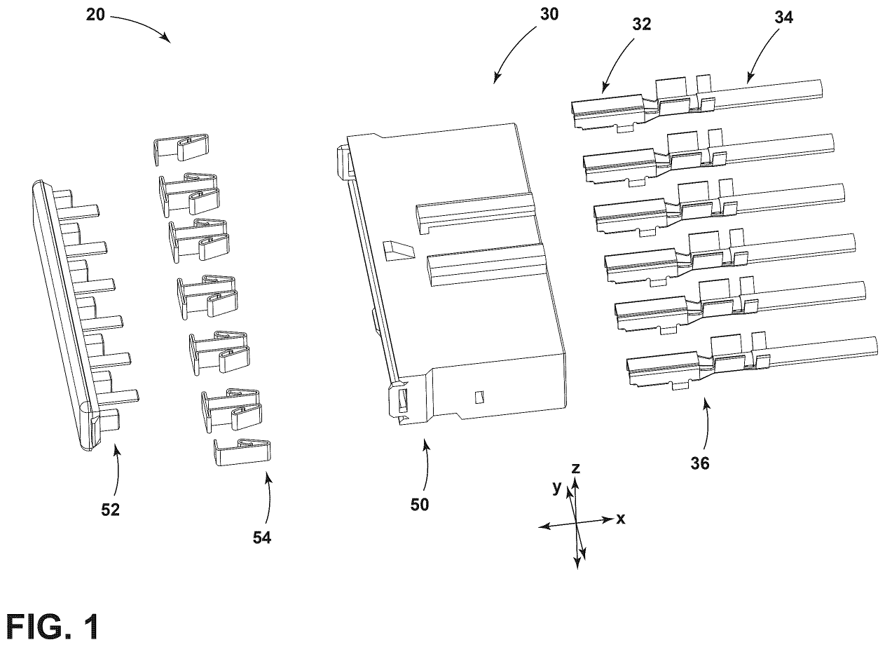

Referring to FIG. 1, an electrical assembly 20 includes an electrical connector 30, a plurality of terminals 32, and a plurality of wires 34 coupled with the plurality of terminals 32 (e.g., electrical terminals). The electrical connector 30 is configured to electrically connect at least two of the electrical terminals 32 and the corresponding wires 34. For example, the electrical connector 30 can function as a splice connector to provide one or more splice connections. The electrical connector 30 includes a housing 50, a cover 52, and a plurality of terminal connectors/54. Some or all of the terminal connectors 54 are optionally provided as busbars. The cover 52 is releasably connectable with the housing 50. In the illustrated example, the plurality of terminals 32 include receiving terminals 36 configured to receive a portion (e.g., a pin, a blade, etc.) of corresponding terminals, but can include other configurations. The electrical connector 30 defines a longitudinal direction X (e.g., a connection direction), a transverse direction Y, and a vertical direction Z.

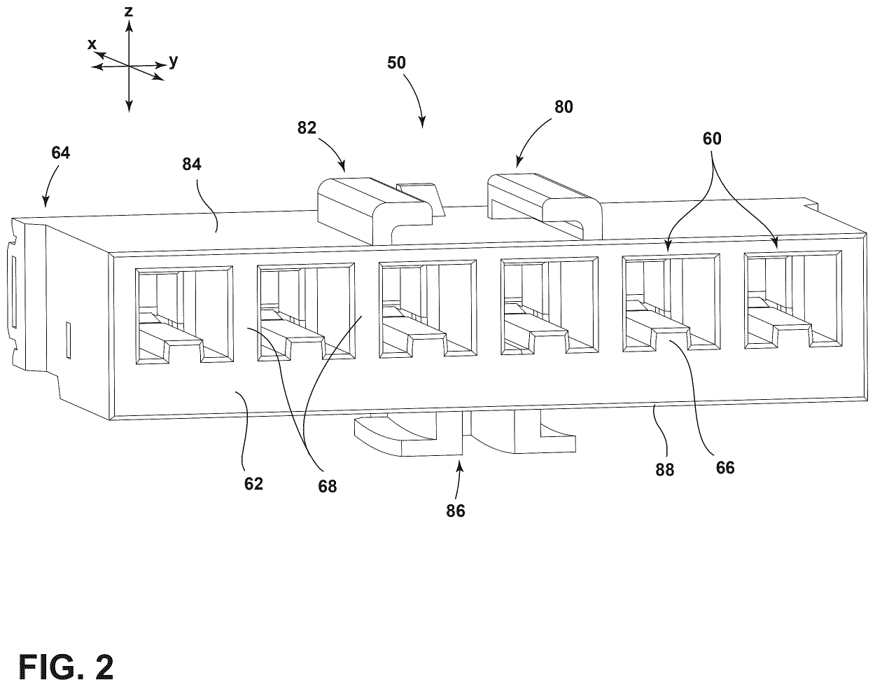

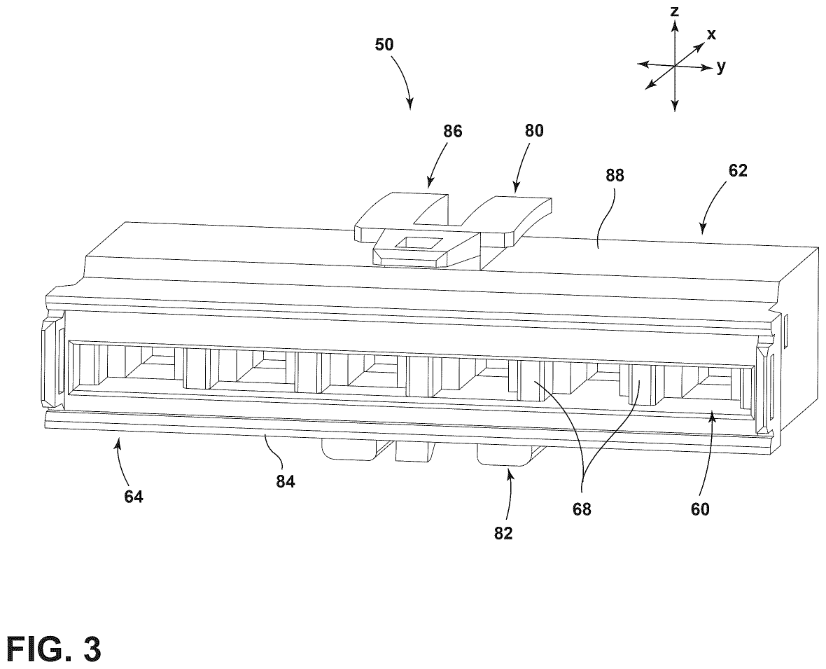

Referring to FIGS. 2 and 3, the housing 50 defines a plurality of terminal channels 60 configured to at least partially receive the plurality of terminals 32 (FIG. 1) and at least partially receive the terminal connectors 54 (FIG. 1). The terminal channels 60 extend through the housing 50 from a first end 62 of the housing 50 to a second end 64 of the housing 50. The plurality of terminals 32 (FIG. 1) are insertable at least partially into the terminal channels 60 from the first end 62. The plurality of terminal connectors 54 (FIG. 1) are insertable at least partially into the terminal channels 60 from the second end 64. The housing 50 optionally includes one or more retainers 66 (e.g., alignment ribs, latch tabs, others) that extend into the terminal channels 60 to retain the plurality of terminals 32 relative to the housing 50. The one or more retainers 66 optionally facilitate alignment of the plurality of terminals 32 (FIG. 1) in the respective terminal channels 60. The housing 50 includes a plurality of inner walls 68 separating the plurality of terminal channels 60. For example, the number of inner walls 68 is one less than the number of terminal channels 60. In the example illustrated in FIGS. 2 and 3, the housing 50 includes six terminal channels 60 disposed side-by-side in a single row and separated by five inner walls 68.

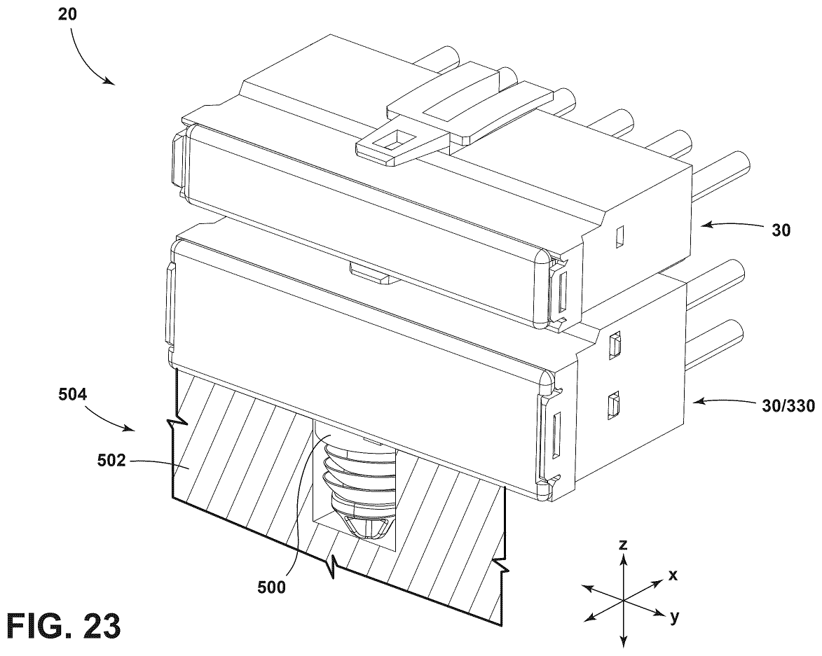

The housing 50 optionally includes one or more formations 80 for releasably coupling with the housing of another electrical connector and/or another component (see, e.g., component 500 in FIG. 23), such as a retaining clip. In the illustrated example, the one or more formations 80 include a first formation 82 extending from a first outer wall 84 of the housing 50 and a second formation 86 extending from a second outer wall 88 of the housing 50. The first outer wall 84 is opposite the second outer wall 88, and the first formation 82 extends in an opposite direction (e.g., in the Z-direction) from the second formation 86. In the illustrated example, the first and second formations 82, 86 include corresponding channels and latches.

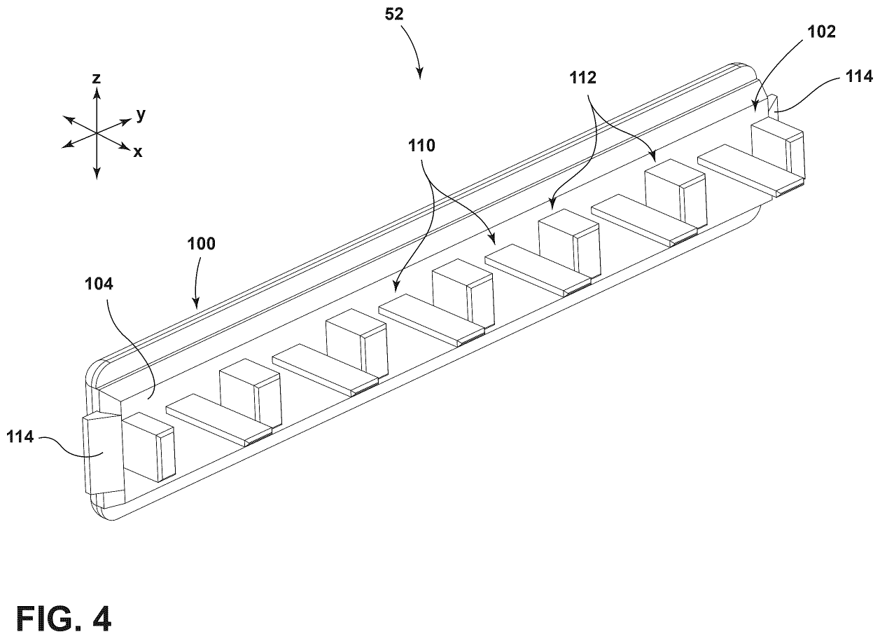

Referring to FIG. 4, the cover 52 includes a cover wall 100 and a plurality of protrusions 102 (e.g., alignment protrusions). The plurality of protrusions 102 extend from an inner surface 104 of the cover wall 100, such as to extend at least partially into the housing 50 and/or to engage with the plurality of terminals 32 (FIG. 1). In the illustrated example, the cover wall 100 is parallel to a Y-Z plane and the plurality of protrusions 102 include first protrusions 110 and second protrusions 112. The first protrusions 110 include blade configurations configured to extend into and engage respective terminals of the plurality of terminals 32. For example, in the illustrated example, the terminals 32 can be configured to at least partially receive blade terminals, and the blade configuration of the first protrusions 110 are shaped to correspond to such blade terminals (e.g., parallel with an X-Y plane) to facilitate insertion into the terminals 32 and limiting movement of the terminals 32. The first protrusions 110 of the cover 52 include a first protrusion for each terminal of the plurality of terminals 32. The first protrusions 110 also acts as separators for the terminal connectors 54.

The second protrusions 112 are shown with a block-shaped configuration and disposed in a row. The second protrusions 112 are disposed in an alternating arrangement with the first protrusions 110. For example, the first protrusions 110 are disposed to align with the terminal channels 60 of the housing 50 (FIG. 3), and the second protrusions 112 are disposed to be aligned between the terminal channels 60, such as with the inner walls 68 (FIG. 2). The second protrusions 112 can limit movement portions of the terminal connectors 54 (FIG. 3), such as in the transverse direction Y. Additionally or alternatively, the second protrusions 112 can be configured to contact surfaces of the housing 50, such as the inner walls 68 (FIG. 3), to limit the insertion depth of the cover 52 into the housing 50. The cover 52 includes one or more tabs 114 to engage the housing 50 (FIG. 3) to limit or prevent relative movement between the cover 52 and the housing 50.

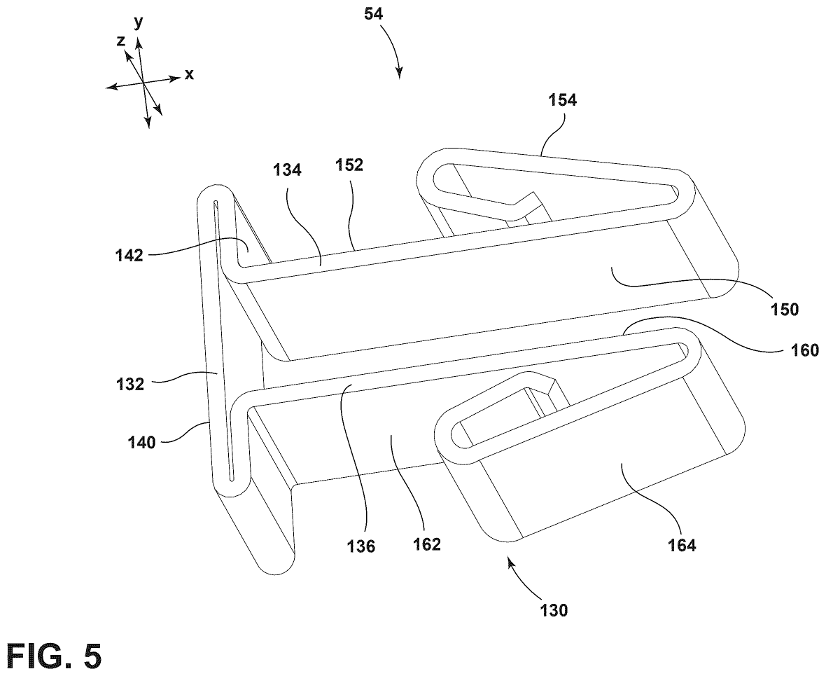

Referring to FIG. 5, the plurality of terminal connectors 54 include one or more first terminal connectors 130. In the illustrated example, the first terminal connectors 130 comprise a base 132, a first spring arm 134, and a second spring arm 136. The first spring arm 134 and the second spring arm 136 extend from the base 132 such that the base 132, the first spring arm 134, and the second spring arm 136 are disposed in a U-shaped configuration. The base 132 includes a first side 140 and a second side 142. The first spring arm 134 and the second spring arm 136 extend from the second side 142 of the base 132.

The first spring arm 134 comprises an inner surface 150, an outer surface 152 and a spring contact 154 extending from the outer surface 152. The second spring arm 136 comprises an inner surface 160, an outer surface 162, and a spring contact 164. The inner surface 150 of the first spring arm 134 and the inner surface 160 of the second spring arm 136 face each other. In the illustrated example, spring arms 134, 136 are parallel with an X-Z plane and the spring contacts 154, 164 comprise hook-shaped configurations that extend outward from the outer surfaces 152, 162 in opposite directions (e.g., generally in the transverse direction Y). The first spring contact 154 is configured to contact a terminal of the plurality of terminals 32 (FIG. 1), and the second spring contact 164 is configured to contact another terminal of the plurality of terminals 32 to electrically connect the two terminals.

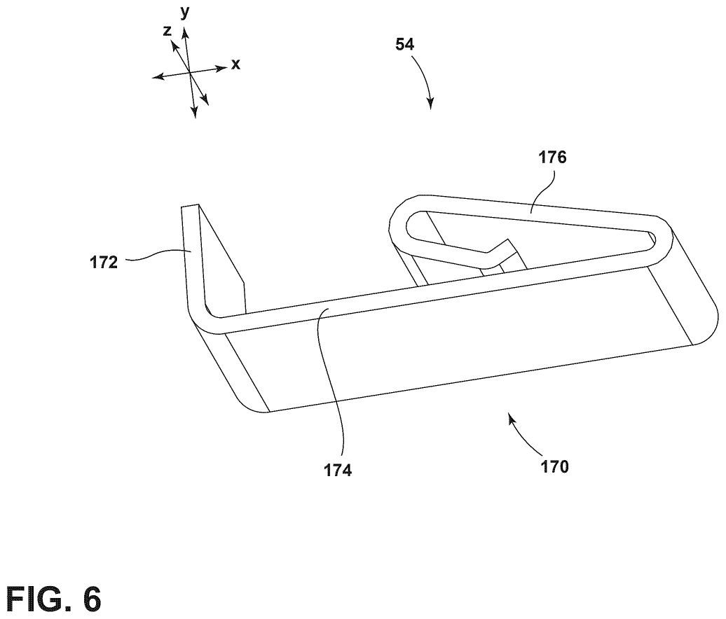

Referring to FIG. 6, the plurality of terminal connectors 54 includes a second terminal connector 170. The second terminal connector 170 includes a base 172, a spring arm 174, and a spring contact 176. The spring contact 176 extends, at least to some degree, toward the spring contact 156, 164 of an adjacent first terminal connector 130 (FIG. 5). The second terminal connector 170 resembles a portion (e.g., about half) of one of the first terminal connectors 130.

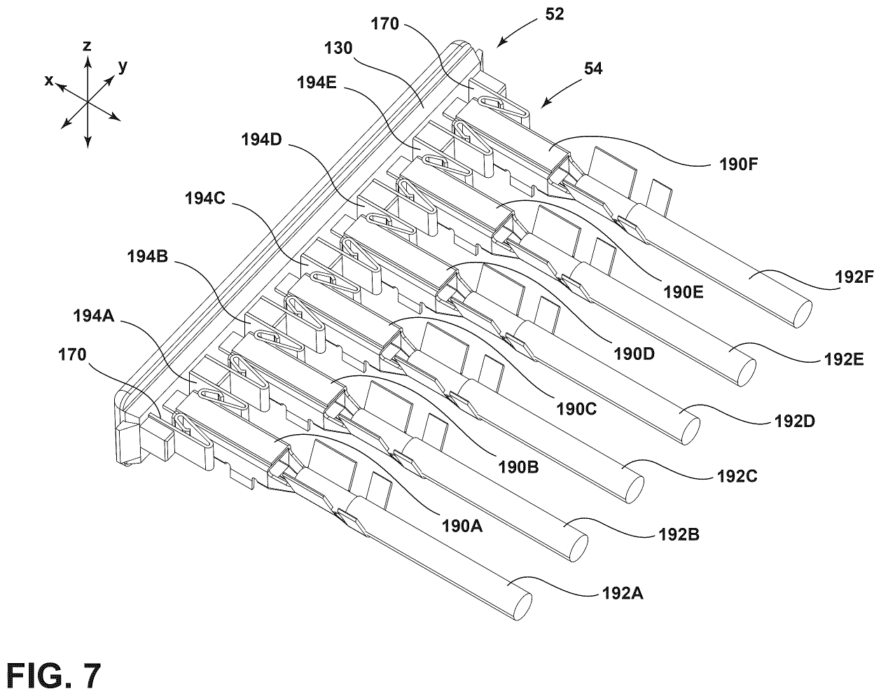

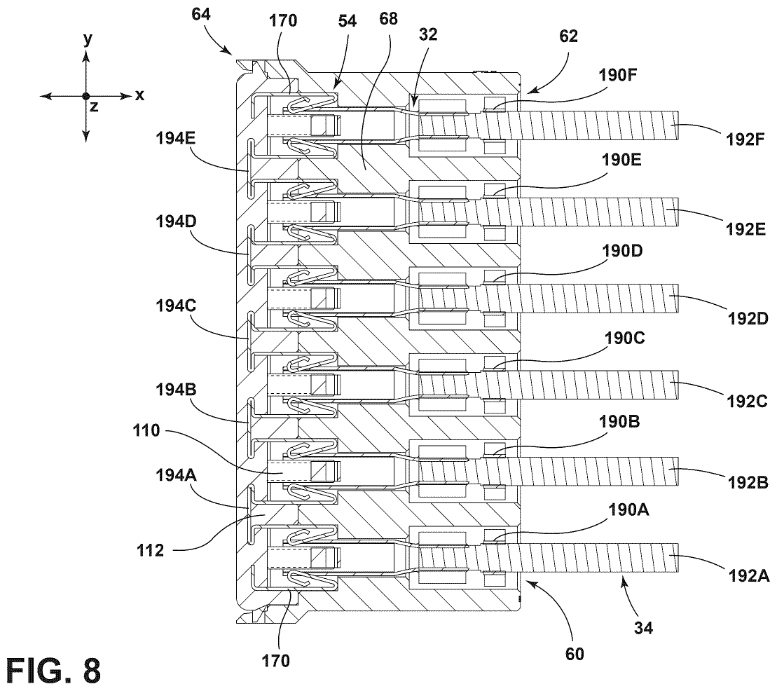

Referring to FIGS. 7 and 8, the plurality of terminal connectors 54 are connected to the cover 52. The housing 50 (FIG. 2) is hidden in FIG. 7. In the illustrated example, the cover 52 is overmolded on the plurality of terminal connectors 54. For example, the cover 52 comprises an electrically insulating material, such as plastic, that is overmolded on one or more first terminal connectors 130 and/or one or more second terminal connectors 170. The first terminal connectors 130 comprise an electrically conductive material (e.g., metal, copper, aluminum, among others). Optionally, one or more second terminal connectors 170 comprise a conductive material. Additionally or alternatively, one or more second terminal connectors 170 comprise an electrically insulating material. For example, one or more second terminal connectors 170 can be integrally formed with the cover 52. In the example illustrated in FIGS. 7 and 8, the plurality of terminals 32 of the electrical assembly 20 includes six terminals 190A-190F connected to six wires 192A-192F of the plurality of wires 34 that are electrically connected together (e.g., spliced) by five first terminal connectors 194A-194E of the one or more first terminal connectors 54. For example, the first terminal connector 194A is in contact with and electrically connects terminals 190A, 190B, the first terminal connector 194B is in contact with and electrically connects terminals 190B, 190C, the first terminal connector 194C is in contact with and electrically connects terminals 190C, 190D, the first terminal connector 194D is in contact with and electrically connects terminals 190D, 190E, and the first terminal connector 194E is in contact with and electrically connects terminals 190E, 190F such that all of terminals 190A-190F are electrically connected together. A pair of the second terminals connectors 170 are disposed at the ends of the cover 52 and are in contact with terminal 190A and terminal connector 190F, respectively, such as to facilitate proper alignment and limit play between the terminals 190A, 190F, the housing 50 (FIG. 8), and the first terminal connectors 194A, 194E.

While illustrated with six terminals and wires 190A-190F, 192A-192F all spliced together, the electrical connector 30 can be utilized with other splice configurations. For example, the electrical connector 30 can provide a single splice for up to six terminals, such as two, three, four, five, or six terminals, and can provide two splices, including one splice with two terminals and one splice with up to three terminals (e.g., by excluding terminal 190C and/or terminal 190D). The different splice configurations can be provided without modification of the electrical connector 30. For example, excluding certain terminals can provide different splice configurations, and the same configuration of terminal connectors 54 can be coupled with the cover 52 in all of the splice configurations, which can limit assembly complexity and allow for the electrical connector 30 to be used in a wider number of applications than other designs. The terminals 32, such as terminals 190A-190F, are disposed in the same orientation (e.g., parallel with the longitudinal direction X) such that the plurality of wires 34 extend out of the housing 50 in the same direction (e.g., from the first end 62 and parallel with the longitudinal direction X). For example, none of the wires 34 in the illustrated example extend from the second end 64 of the housing 50.

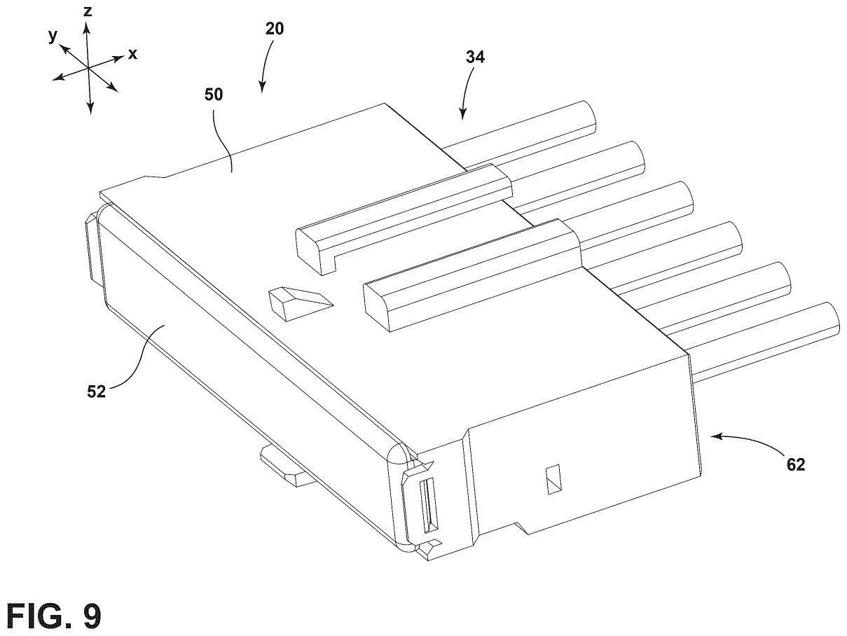

FIG. 9 illustrates an assembled configuration of the electrical assembly 20, with the cover 52 coupled with the housing 50 and the wires 34, which are connected to respective terminals 32 (FIG. 8) and spliced together, extending from the first end 62 of the housing 50.

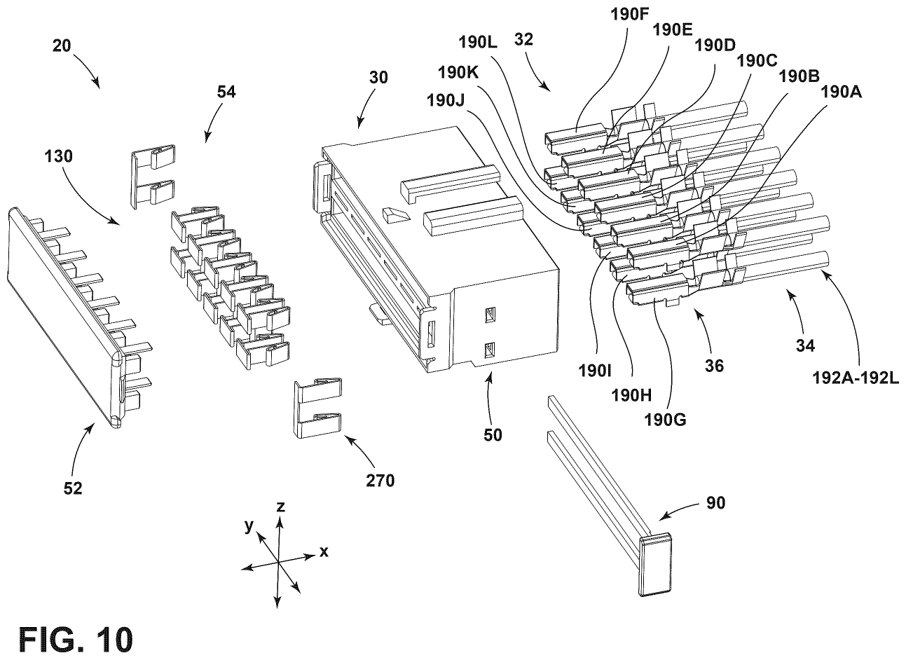

Referring to FIG. 10, the plurality of terminals 32 and the plurality of wires 34 can include a plurality of rows of terminals and wires, such as two rows each including six terminals of the plurality of terminals 32 and six wires of the plurality of wires 34 (e.g., twelve pairs of terminals and wires). For example, the first row includes a first set of terminals 190A-190F and wires 192A-192F, and the second row includes a second set of terminals 190G-190L and wires 192G-192L. The first set of terminals 190A-190F are electrically connected together by first terminal connectors 130. The second set of terminals 190G-190L are also electrically connected together by the first terminal connectors 130. The first and second sets of terminals 190A-190F, 190G-190L are electrically connected by second terminals 270. Optionally, sets of terminals, such as the first set of terminals 190A-190F or the second set of terminals 190G-190L, include at least two terminals and less than or equal to eight terminals, or at least three terminals and less than or equal to eight terminals.

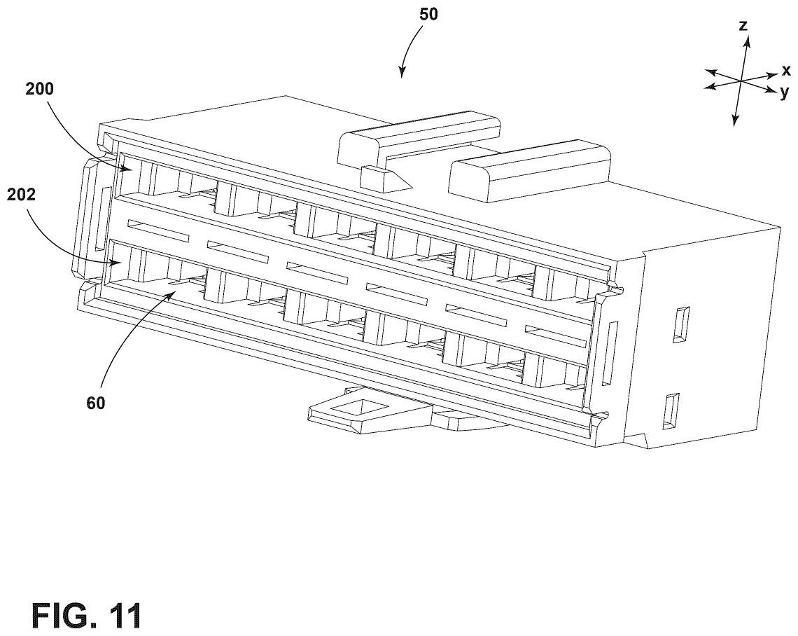

The connector 30 optionally includes a retainer 90 that slides into a side of the housing 50 to restrict movement of the terminals 32, such as to provide terminal position assurance (TPA). The housing 50, the cover 52, and the terminal connectors 54 of the electrical connector 30 can be configured for rows of terminals and wires. For example, the housing 50 can include a plurality of rows of the terminal channels 60 that correspond to the rows of terminals and wires, such as generally illustrated in FIG. 11. In the illustrated example, the housing 50 includes first and second rows of terminal channels 200, 202 that each include six terminal channels (e.g., twelve total terminals channels) of the plurality of terminal channels 60. In other examples, the housing 50 can include other numbers of terminal channels 60 and/or other numbers of rows of terminal channels 60.

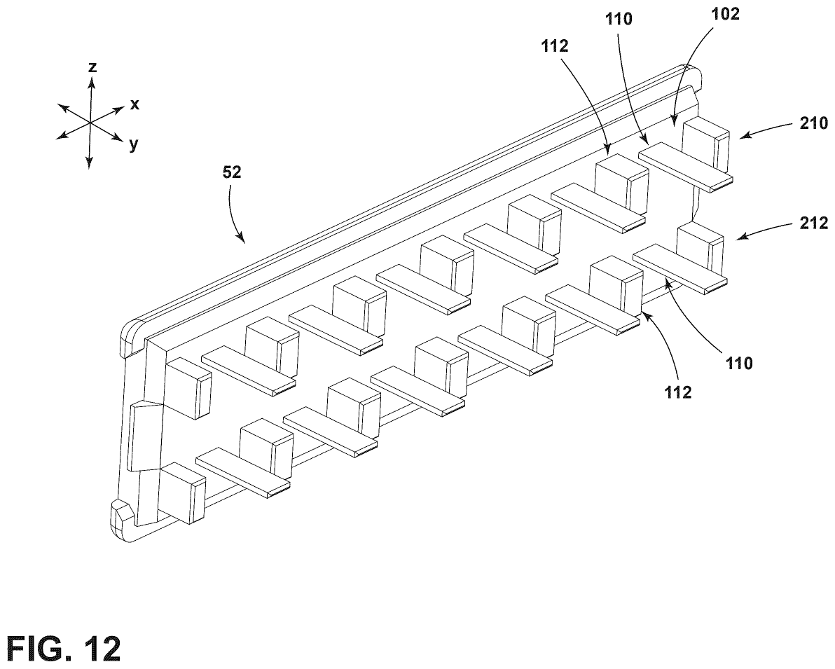

Referring to FIG. 12, the illustrated cover 52 includes a plurality of rows of the protrusions 102, such as a first row of protrusions 210 and a second row of protrusions 212. The first and second rows of protrusions 210, 212 can each include a subset of the first protrusions 110 and the second protrusions 112. For example, the first row of protrusions 210 can include six first protrusions 110 configured to extend into the first row of terminal channels 200 (FIG. 11) and seven second protrusions 112 disposed in an alternating arrangement with the first protrusions 110, and the second row of protrusions 212 can include another six first protrusions 110 configured to extend into the second row of terminal channels 202 (FIG. 11) and another seven second protrusions 112 disposed in an alternating arrangement with the first protrusions.

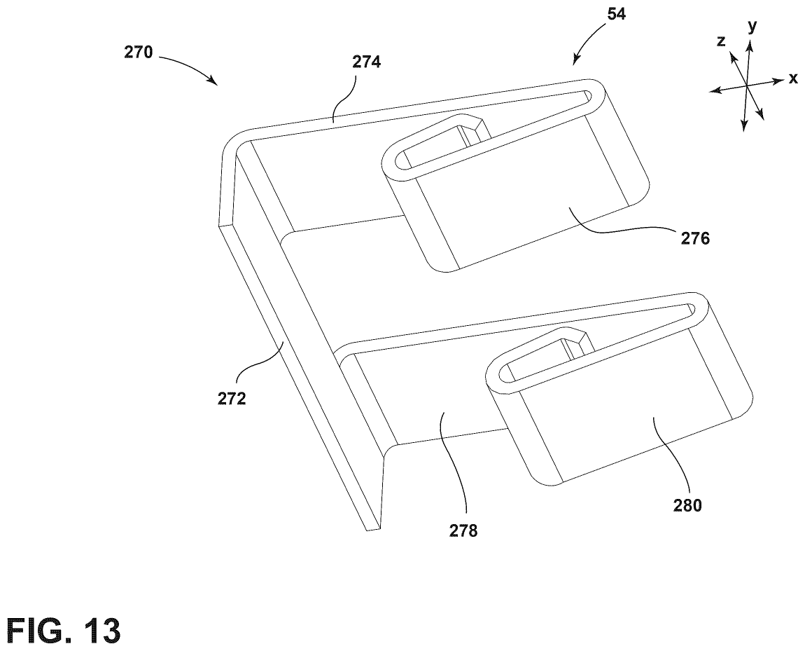

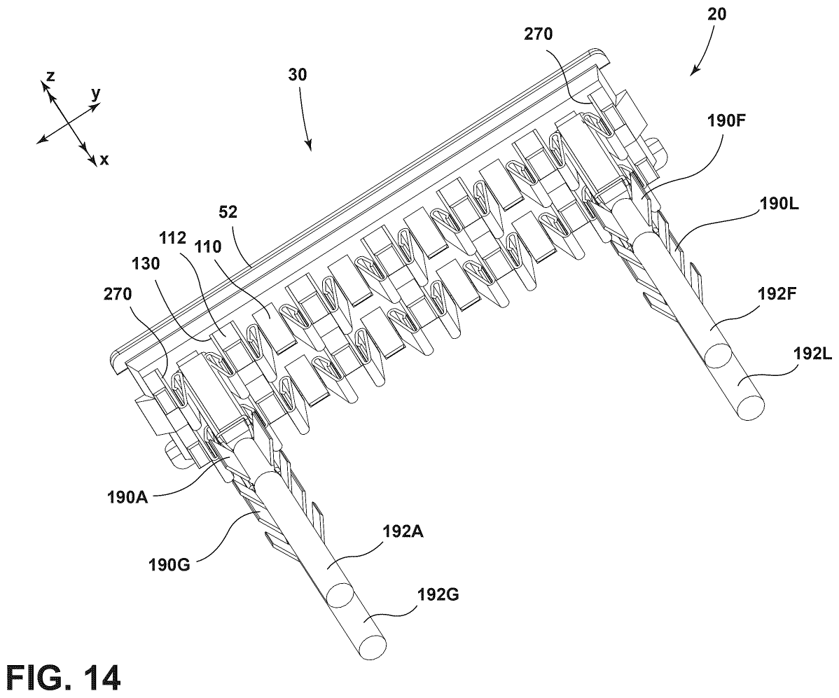

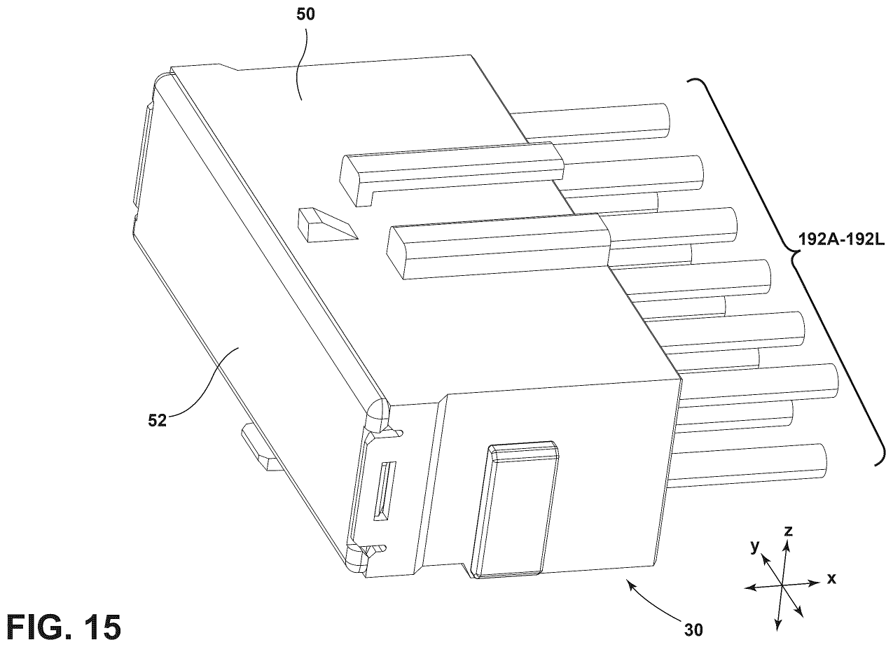

Referring to FIG. 13, a second terminal connector 270 (e.g., a busbar) is illustrated for use with the connector 30 of FIG. 10. The second terminal connector 270 includes a similar configuration to that of the second terminal connector 170 (FIG. 6). For example, the second terminal connector 270 includes a base 272, a first spring arm 274 extending from the base 272, and a first spring contact 276 extending from the first spring arm 274. With the second terminal connector 270, the base 272 is longer than the base 172 (e.g., in the vertical direction Z), and the second terminal connector 270 further includes a second spring arm 278 and a second spring contact 280 extending from second spring arm 278. In the illustrated example, the first spring arm 274 and the second spring arm 278 are parallel and at least partially coplanar (e.g., in an X-Z plane). The first spring contact 276 and the second spring contact 280 extend in the same direction (e.g., the transverse direction) from the first spring arm 274 and the second spring arm 278, respectively. The second terminal connector 270 includes an electrically conductive material, such as the same material as the first terminal connectors 130 (FIG. 10), and is configured to electrically connect a pair of terminals in adjacent rows. In the example illustrated in FIG. 14, the electrical connector 30 includes a pair of second terminal connectors 270, including one second terminal connector 270 that electrically connects terminal 190A with terminal 190G, and another second terminal connector 270 that electrically connects terminal 190F with terminal 190L. A cross-sectional view of the electrical connector 30 of FIG. 10 would be similar to or the same as the cross-sectional view shown in FIG. 8 with second terminal connectors 170 replaced with second terminal connectors 270. An assembled configuration of the electrical connector 30 of FIG. 10 is illustrated in FIG. 15 with the cover 52 releasably coupled with the housing 50, and the wires 192A-192L extending from the housing 50.

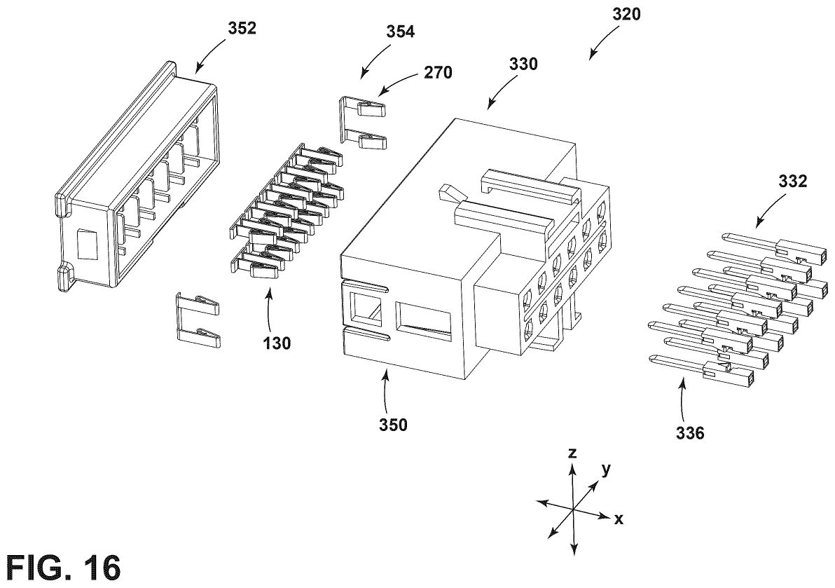

Referring to FIG. 16, an electrical assembly 320 is illustrated that includes aspects similar to those of the electrical assembly 20 illustrated in FIGS. 10-15. For example, the electrical assembly 320 includes an electrical connector 330 and a plurality of terminals 332. A plurality of wires (e.g., wires 34 of FIG. 10) can be coupled with the plurality of terminals 332. The electrical connector 330 includes a housing 350, a cover 352, and a plurality of terminal connectors 354 (e.g., busbars). The plurality of terminals 332 include protruding terminals 336, such as instead of the receiving terminals 36 shown of the electrical assembly 20 (FIGS. 1, 7, 8, 10, and 14). The housing 350 and the cover 352 are configured for use with the protruding terminals 336. For example, the housing 350 is configured to at least partially receive the protruding terminals 336, and the cover 352 is configured to engage the protruding terminals 336. The plurality of terminal connectors 354 include the same or a similar configuration as the terminal connectors 54 of FIG. 10. For example, the plurality of terminal connectors 354 can include the first terminal connectors 130 and the second terminal connectors 270. The plurality of terminal connectors 354 are coupled with the cover 352. For example, the cover 352 is overmolded onto the plurality of terminal connectors 354.

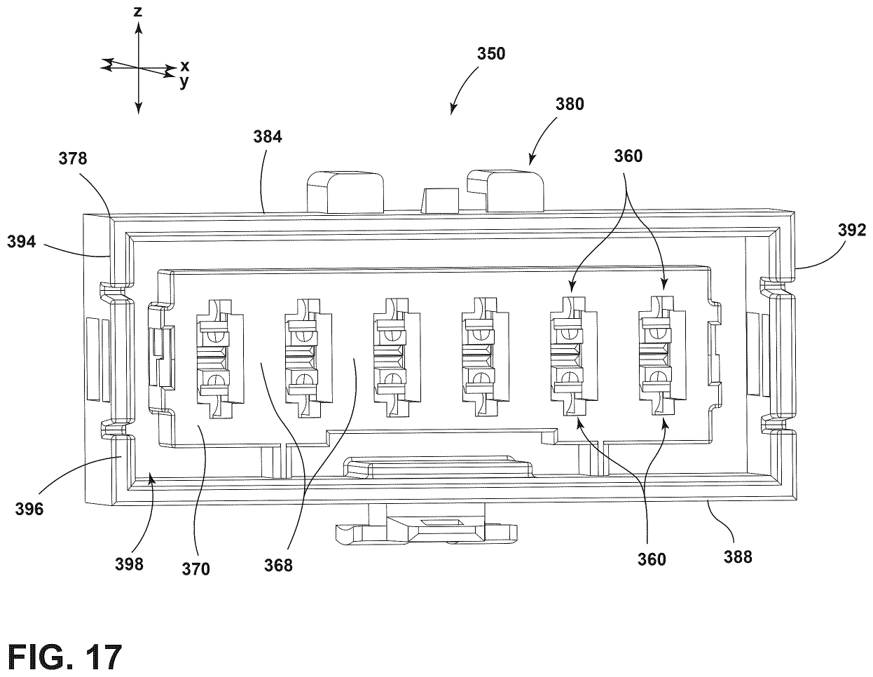

As illustrated in FIG. 17, the housing 350 includes a plurality terminal channels 360 configured to at least partially receive and/or retain the protruding terminals 336. The housing 350 is configured to engage the cover 352 (FIG. 16). The housing 350 includes a plurality of inner walls 368 that at least partially define the plurality of terminal channels 360. The plurality of inner walls 368 extend to an intermediate surface 370. The housing 350 includes an outer peripheral wall 378 defined by a first outer wall 384, a second outer wall 388, a third outer wall 392, and a fourth outer wall 394. In the illustrated example, the outer walls 384, 388, 392, 394 are disposed in a rectangular configuration. An outer edge 396 of the peripheral wall 378 is offset from (e.g., disposed beyond in the longitudinal direction X) the intermediate surface 370 such that the intermediate surface 370 and the peripheral wall 378 at least partially define a recess 398 to receive at least a portion of the cover 352 (FIG. 16). The housing 350 can include one or more formations 380 for coupling with a housing of another connector, such as the housing 50 of the connector 30 (FIGS. 1 and 10). For example, the one or more formations 380 (FIG. 17) include the same and/or corresponding configurations as the formations 80 of the housing 50 (FIGS. 2 and 3).

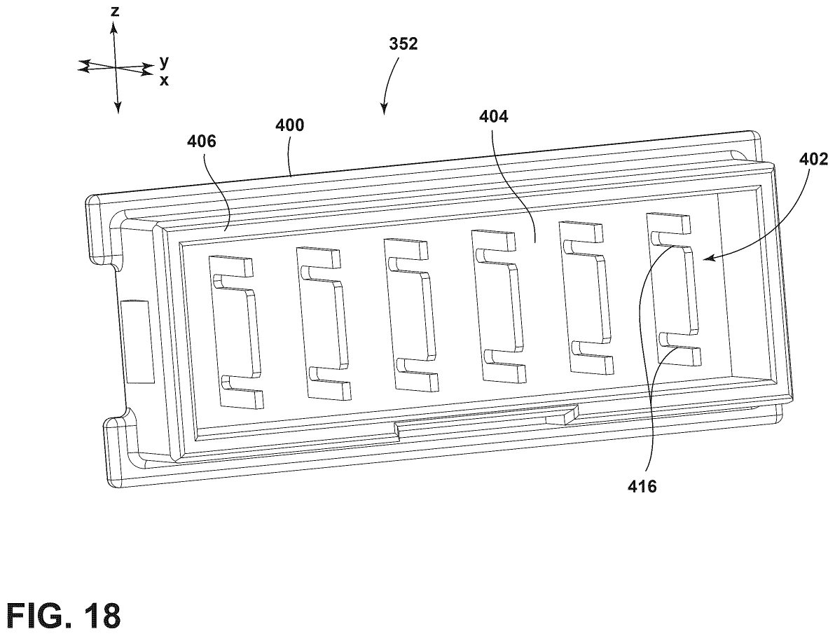

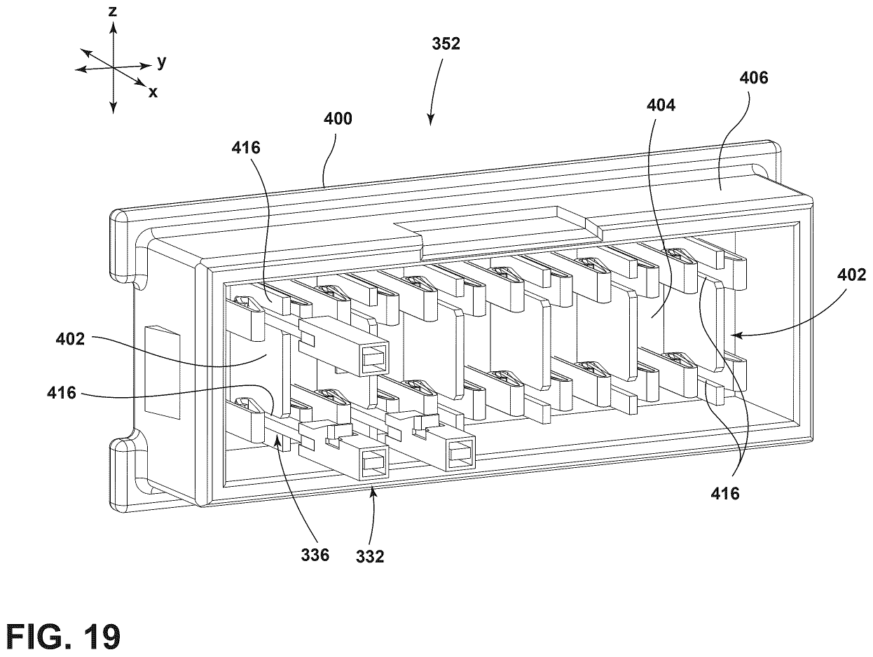

Referring to FIGS. 18 and 19, the cover 352 includes a cover wall 400 and a plurality of protrusions 402. The cover wall 400 includes an inner surface 404 from which the plurality of protrusions 402 extend. The cover 352 includes a peripheral wall 406 that extends from the inner surface 404 for insertion into and/or engagement with the housing 350 (FIG. 17). The plurality of protrusions 402 each comprise a pair of slots 416 each configured receive portions of two electrical terminals, respectively, of the plurality of terminals 332, such as the protruding terminals 336, as illustrated with leftmost protrusion 402 in FIG. 19. In the illustrated example, the plurality of protrusions 402 are planar and parallel with an X-Z plane, each other, and the third and fourth outer walls 392, 394 of the housing 350 (FIG. 17).

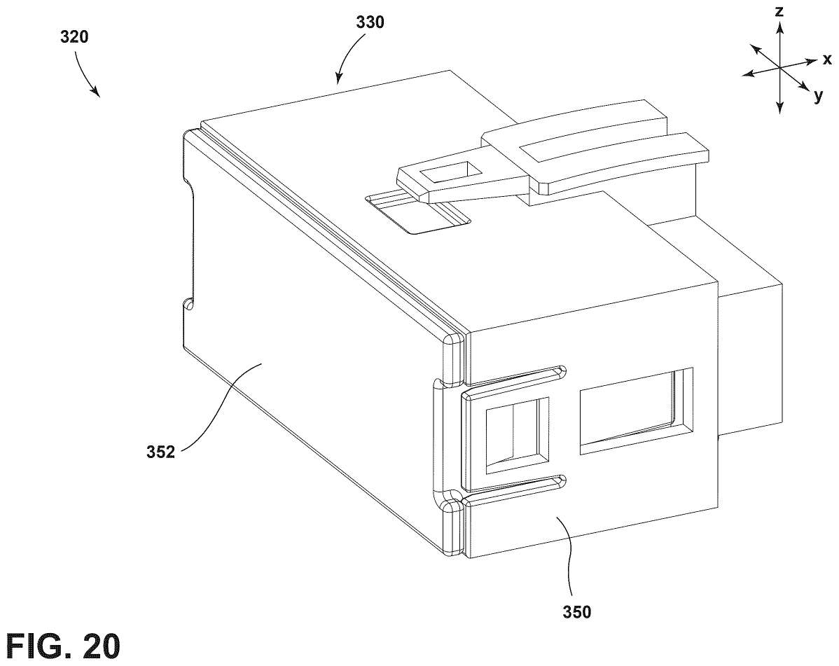

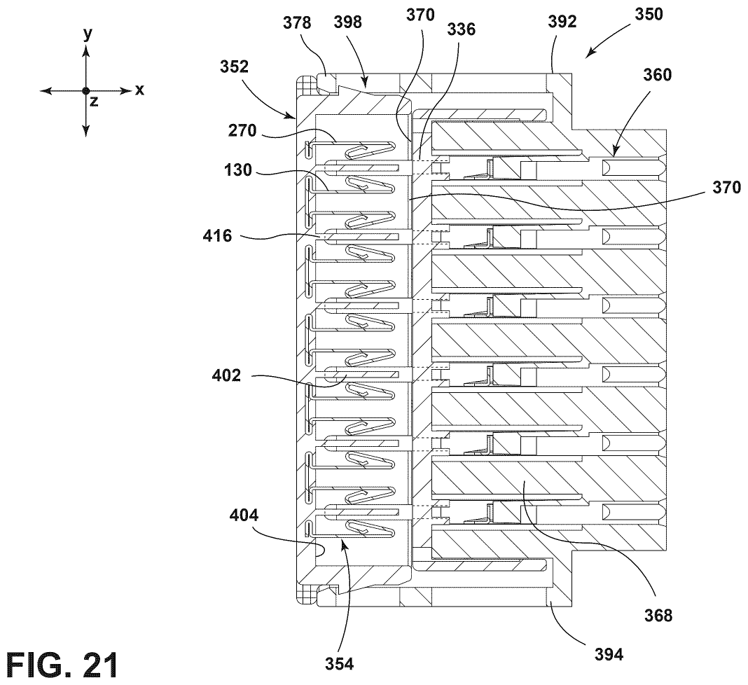

Referring to FIG. 20, a perspective view of the electrical assembly 320 in an assembled configuration is illustrated, with the cover 352 coupled with the housing 350. A cross-sectional view of the assembled configuration is illustrated in FIG. 21. In the assembled configuration, the cover 352 is engaged with the housing 350 and disposed at least partially in the recess 398. The protruding terminals 336 are illustrated in respective terminals channels 360 of the housing. The protruding terminals 336 extend beyond the intermediate surface 370 such that that the protruding terminals 336 extend between and are in contact with respective pairs of adjacent terminal connectors 354, and are disposed partially in respective slots of the plurality of slots 416. The cover 352 is overmolded onto the terminal connectors 354. The terminal connectors 354 extend from the cover 352 toward the intermediate surface 370 such that the terminal connectors 354 are adjacent to and at least partially aligned with respective terminal channels 360. For example, a distance (e.g., in the longitudinal direction X) between the terminal connectors 354 and the intermediate surface 370 can be 20% or less, 10% or less, or 5% or less, of a terminal length of the terminals 32 in the longitudinal direction X.

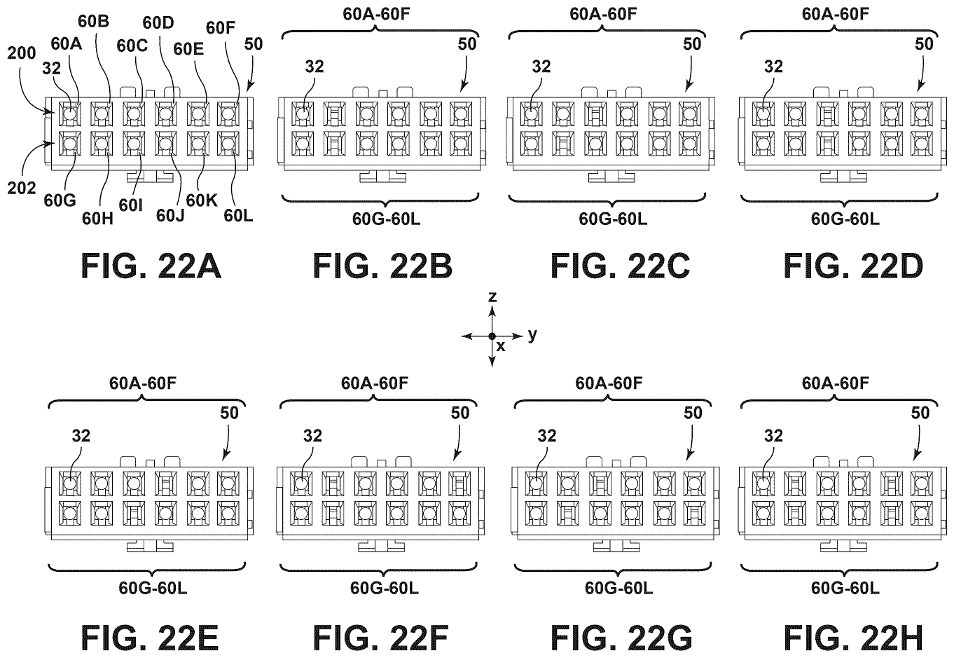

The electrical connectors 30, 330, including the terminal connectors 54, 354 (FIGS. 10, 16) thereof, are configured to provide a splice or a plurality of splices for electrically connecting at least two of the terminals 32, 332 in a plurality of splice configurations. FIGS. 22A-22H illustrate examples of such splice configurations in connection with the electrical connector 30, but the illustrated splice configurations are also applicable to the electrical connector 330. In the illustrated examples, the housing 50 includes twelve terminal channels 60A-60L for at least partially receiving up to twelve terminals 32, and the plurality of splice configurations includes eight splice configurations illustrated in FIGS. 22A-22H, respectively. For example, a first splice configuration illustrated in FIG. 22A includes a single splice for electrically connecting up to twelve electrical terminals of the plurality of terminals 32 (e.g., two, three, four, five, six, seven, eight, nine, ten, eleven, or twelve terminals). The illustrated example provides a single splice for twelve terminals, but can be utilized with fewer terminals by omitting one terminal (e.g., for splicing eleven terminals) or multiple adjacent terminals (e.g., in the same row of terminal channels 200, 202, or terminals in end terminal channels, such as terminal channels 60A, 60G or terminal channels 60F, 60L).

A second splice configuration illustrated in FIG. 22B includes one splice for electrically connecting two terminals of the plurality of terminals 32 and one splice for electrically connecting up to eight terminals of the plurality of terminals 32. The second splice configuration is provided by omitting at least the terminals from the terminal channels adjacent to one pair of adjacent terminal channels with terminals. In the illustrated example, the terminals 32 in terminal channels 60A, 60G are electrically connected together, terminals are omitted from the two adjacent terminal channels, terminal channels 60B, 60H, and, separately, the terminals 32 in terminal channels 60C, 60D, 60E, 60F, 60L, 60K, 60J, 60I are electrically connected together.

A third splice configuration illustrated in FIG. 22C includes one splice for electrically connecting three electrical terminals of the plurality of terminals 32 and one splice for electrically connecting up to seven terminals of the plurality of terminals 32. The third splice configuration is provided by omitting at least the terminals from the terminal channels adjacent to one set of three adjacent terminal channels with terminals. In the illustrated example, the terminals 32 in terminal channels 60A, 60B, 60G are electrically connected together, terminals are omitted from the two adjacent terminal channels, terminal channels 60C, 60H, and, separately, the terminals 32 terminal channels 60D, 60E, 60F, 60L, 60K, 60J, 60I are electrically connected together.

A fourth splice configuration illustrated in FIG. 22D includes one splice for electrically connecting four electrical terminals of the plurality of terminals 32 and one splice for electrically connecting up to six terminals of the plurality of terminals 32. The fourth splice configuration is provided by omitting at least the terminals from the terminal channels adjacent to one set of four adjacent terminal channels with terminals. In the illustrated example, the terminals 32 in terminal channels 60A, 60B, 60G, 60H are electrically connected together, terminals are omitted from the two adjacent terminal channels, terminal channels 60C, 60I, and, separately, the terminals 32 in terminal channels 60D, 60E, 60F, 60L, 60K, 60J are electrically connected together.

A fifth splice configuration illustrated in FIG. 22E includes one splice for electrically connecting five electrical terminals of the plurality of terminals 32 and one splice for electrically connecting up to five terminals of the plurality of terminals 32. The fifth splice configuration is provided by omitting at least the terminals from the terminal channels adjacent to one set of five adjacent terminal channels with terminals. In the illustrated example, the terminals 32 in terminal channels 60A, 60B, 60C, 60G, 60H are electrically connected together, terminals are omitted from the two adjacent terminal channels, terminal channels 60D, 60I, and, separately, the terminals 32 in terminal channels 60E, 60F, 60L, 60K, 60J are electrically connected together.

A sixth splice configuration illustrated in FIG. 22F includes one splice for electrically connecting two electrical terminals of the plurality of terminals 32, one splice for electrically connecting up to three terminals of the plurality of terminals 32 (e.g., two or three terminals), and one splice for electrically connecting four terminals of the plurality of terminals 32. The sixth splice configuration is provided by omitting at least the terminals from the terminal channels adjacent to one pair of terminal channels with terminals and the terminal channel adjacent to a set of four adjacent terminal channels with terminals. In the illustrated example, the terminals 32 in terminal channels 60A, 60G, are electrically connected together, terminals are omitted from the two adjacent terminal channels, terminal channels 60B, 60H, the terminals 32 in the terminal channels 60I, 60J, 60K, 60L are electrically connected, a terminal is omitted from terminal channel 60F, and the terminals 32 in terminal channels 60C, 60D, 60E are electrically connected together.

A seventh splice configuration illustrated in FIG. 22G includes three splices each for electrically connecting up to three (e.g., two or three) electrical terminals of the plurality of terminals 32. The seventh splice configuration is provided by omitting at least the terminals from the terminal channels adjacent to three sets of two or three terminal channels with terminals. In the illustrated example, the terminals 32 in terminal channels 60A, 60B, 60G are electrically connected together, terminals are omitted from the two adjacent terminal channels, terminal channels 60C, 60H, the terminals 32 in terminal channels 60D, 60E, 60F are electrically connected together, a terminal is omitted from terminal channel 60L, and the terminals 32 in the terminal channels 60I, 60J, 60K are electrically connected.

An eighth splice configuration illustrated in FIG. 22H includes four splices each for electrically connecting a pair of electrical terminals of the plurality of terminals 32. The eighth splice configuration is provided by omitting the terminals from the terminal channels adjacent to the four pairs of terminal channels with terminals. In the illustrated example, the terminals 32 in terminal channels 60A, 60G, are electrically connected together, terminals are omitted from the two adjacent terminal channels, terminal channels 60B, 60H, the terminals 32 in terminal channels 60C, 60D are electrically connected together, a terminal is omitted from terminal channel 60E, the terminals 32 in the terminal channels 60F, 60L are electrically connected, a terminal is omitted from terminal channel 60K, and the terminals 32 in the terminal channels 60I, 60J are electrically connected together.

With each of the splice configurations, the terminal connectors 54 (FIG. 10) are disposed in the same configuration, which allows the same connector 30 to be used for a plurality of different splice configurations without modification. For example, with a connector 30 having twelve terminal channels 60, the plurality of terminal connectors 54 includes ten first terminal connectors 130 and two second terminal connectors 270 connected to the cover 52 in the same configuration. Utilizing the same connector for different splice connections can reduce manufacturing complexity and/or reduce the number of different components in an electrical assembly.

While electrical connectors 30, 330 are illustrated separately, features of the electrical connectors 30, 330 can be combined and are not mutually exclusive. For example, a housing and a cover could include some terminal channels and protrusions for receiving terminals (e.g., receiving terminals 36) and also include some terminal channels and protrusions for protruding terminals (e.g., protruding terminals 336). Additionally or alternatively, an electrical assembly can include one or more of the electrical connector 30 (e.g., for splicing a first set of multiple terminals and wires) and one or more of the electrical connector 330 (e.g., for splicing a second set of multiple terminals and wires).

As generally illustrated in FIG. 23, the electrical connectors 30 (and/or the electrical connector 330 of FIG. 16) can be stacked and latched together. For example, a connector 30 with six terminal channels 60 (FIG. 1) can be stacked with another connector 30 with twelve terminal channels 60 (FIG. 10), which can be connected to another component 500, such as a retaining clip, for connecting the electrical connectors 30 with a mounting surface 502, such as of a vehicle 504. The vehicle 504 can include the electrical assembly 20, which can include one or more of the electrical connectors 30. Additionally or alternatively, the vehicle 504 can include the electrical assembly 320, which can include one or more of the electrical connectors 330 (FIG. 16).

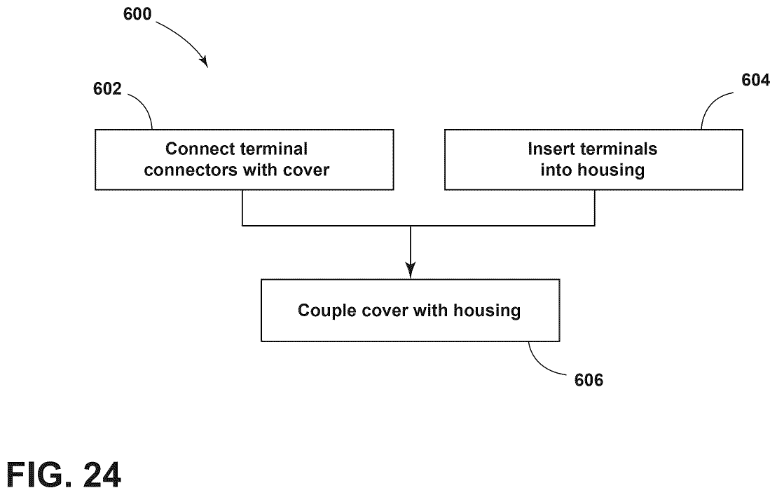

Referring to FIG. 24, a method 600 of assembling an electrical assembly is illustrated that can be utilized with the electrical assemblies 20 (FIGS. 1-15), 320 (FIGS. 16-20). The method 600 includes connecting the terminal connectors 54, 354 (e.g., busbars) with the cover 52, 352 (block 602), which can include overmolding the cover 52, 352 onto the terminal connectors 54, 354. The method 600 includes inserting the plurality of terminals 32, 332 into the housing 50, 350 (block 604), such as into respective terminal channels 60, 360. Inserting the plurality of terminals 32, 332 (block 604) can include inserting terminals into some of the terminal channels 60, 360 and omitting terminals from other terminal channels 60, 360, such as to provide a splice of less than a maximum number of terminals, or to provide multiple splices. For example, inserting the terminals 32, 332 (block 604) can including inserting the terminals 32, 332 in one of a plurality of splice configurations, such as generally illustrated in FIGS. 22A-22H. The method 600 includes coupling the cover 52, 352 with the housing 50, 350 (block 606), which electrically connects the terminals 32, 332 of the splice(s). Connecting the terminal connectors 54, 354 with the cover 52, 352 (block 602) and coupling the cover 52, 352 with the housing 50, 350 (block 606) can be conducted in the same manner regardless of how many terminals 32, 332 are inserted into the housing 50, 350 or the configuration in which the terminals 32, 332 are inserted. Coupling the cover 52, 352 with the housing 50, 350 (block 606) includes inserting the terminals 32, 332 partially between adjacent terminal connectors 54, 354 such that each terminal 32, 332 is in contact with two terminal connectors 54, 354. Inserting the terminals 32, 332 partially between adjacent terminal connectors 54, 354 includes overcoming a spring force of and bending or otherwise deforming respective spring contacts (e.g., spring contacts 154, 164, 176, 276, 280) of the terminal connectors 54, 354.

The instant disclosure includes the following non-limiting embodiments:

An electrical connector, comprising: a housing at least partially defining a plurality of terminal channels configured to at least partially receive a plurality of electrical terminals; a cover releasably connected to the housing; and a plurality of first terminal connectors connected to the cover and each disposed partially in or adjacent to two terminal channels of the plurality of terminal channels to electrically connect a respective two electrical terminals of the plurality of electrical terminals.

The electrical connector of any preceding embodiment, wherein the plurality of terminal channels extend from a first end of the housing to a second end of the housing such that the plurality of terminal channels are open at the first end and closed by the cover at the second end.

The electrical connector of any preceding embodiment, wherein the plurality of terminal channels are disposed in at least one row of terminal channels.

The electrical connector of any preceding embodiment, wherein the at least one row of terminal channels includes a first row of terminal channels and a second row of terminal channels; the plurality of first terminal connectors includes a first set of first terminal connectors configured to electrically connect adjacent electrical terminals of the plurality of electrical terminals disposed in the first row of terminal channels; the plurality of first terminal connectors include a second set of first terminal connectors configured to electrically connect adjacent electrical terminals of the plurality of electrical terminals disposed in the second row of terminal channels; and the electrical connector further comprises a plurality of second terminal connectors each configured to electrically connect an electrical terminal of the plurality of electrical terminals in the first row of terminal channels with an electrical terminal of the plurality of electrical terminals in the second row of terminal channels.

The electrical connector of any preceding embodiment, wherein the plurality of second terminal connectors have a different configuration than the plurality of first terminal connectors.

The electrical connector of any preceding embodiment, wherein the plurality of first terminal connectors comprise spring contacts extending in opposite directions; and

the plurality of second terminal connectors comprise spring contacts extending in the same direction.

The electrical connector of any preceding embodiment, wherein the housing and the cover are electrically insulating, and the plurality of first terminal connectors are electrically conductive.

The electrical connector of any preceding embodiment, wherein a first terminal connector of the plurality of first terminal connectors comprises a base connected to the cover, a first spring arm extending from the base and disposed at least partially in a first terminal channel of the plurality of terminal channels, and a second spring arm extending from the base and disposed at least partially in a second terminal channel of the plurality of terminal channels; and wherein the base, the first spring arm, and the second spring arm are disposed in a U-shaped configuration.

The electrical connector of any preceding embodiment, wherein the cover is in contact with a first side of the base, a second side of the base, an inner surface of the first spring arm, and an inner surface of the second spring arm.

The electrical connector of any preceding embodiment, wherein the cover is overmolded on the plurality of terminal connectors.

The electrical connector of any preceding embodiment, wherein the cover comprises a plurality of alignment protrusions extending into the plurality of terminal channels and configured to engage the plurality of electrical terminals.

The electrical connector of any preceding embodiment, wherein the plurality of alignment protrusions include blade configurations configured to extend into respective electrical terminals of the plurality of electrical terminals.

The electrical connector of any preceding embodiment, wherein the plurality of alignment protrusions each comprise a pair of slots configured to receive a portion of two electrical terminals of the plurality of electrical terminals.

The electrical connector of any preceding embodiment, wherein the plurality of terminal channels comprise twelve terminal channels; the plurality of terminal connectors are configured to provide eight different splice configurations; and the plurality of terminal connectors are disposed in the same configuration with each of the eight splice configurations.

The electrical connector of any preceding embodiment, wherein the eight different splice configurations comprise: (i) a single splice for electrically connecting up to twelve electrical terminals of the plurality of electrical terminals; (ii) one splice for electrically connecting two electrical terminals of the plurality of electrical terminals, and one splice for electrically connecting up to eight electrical terminals of the plurality of electrical terminals; (iii) one splice for electrically connecting three electrical terminals of the plurality of electrical terminals, and one splice for electrically connecting up to seven electrical terminals of the plurality of electrical terminals; (iv) one splice for electrically connecting four electrical terminals of the plurality of electrical terminals, and one splice for electrically connecting up to six electrical terminals of the plurality of electrical terminals; (v) one splice for electrically connecting five electrical terminals of the plurality of electrical terminals, and one splice for electrically connecting up to five electrical terminals of the plurality of electrical terminals; (vi) one splice for electrically connecting two electrical terminals of the plurality of electrical terminals, one splice for electrically connecting up to three electrical terminals of the plurality of electrical terminals, and one splice for electrically connecting four electrical terminals of the plurality of electrical terminals; (vii) three splices, each for electrically connecting up to three electrical terminals of the plurality of electrical terminals; and (viii) four splices, each for electrically connecting two electrical terminals of the plurality of electrical terminals.

An electrical assembly, comprising the electrical connector of any preceding embodiment; the plurality of electrical terminals; and a plurality of wires each connected to a respective electrical terminal of the plurality of electrical terminals.

The electrical assembly of any preceding embodiment, wherein the plurality of electrical terminals are disposed in the same orientation such that the plurality of wires extend out of the housing in the same direction.

The electrical assembly of any preceding embodiment, wherein the plurality of electrical terminals include a first set of electrical terminals electrically connected via the plurality of terminal connectors and a second set of electrical terminals electrically connected via the plurality of terminal connectors.

The electrical assembly of any preceding embodiment, wherein the first set of electrical terminals includes at least three electrical terminals and less than or equal to eight electrical terminals.

The electrical assembly of any preceding embodiment, wherein the electrical connector is a first electrical connector; and the electrical assembly further comprises a second electrical connector releasably coupled with the first electrical connector in a stacked configuration.

A vehicle comprising the electrical connector of any preceding embodiment.

A vehicle comprising the electrical assembly of any preceding embodiment.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. An electrical connector, comprising:
a housing at least partially defining a plurality of terminal channels configured to at least partially receive a plurality of electrical terminals;
a cover releasably connected to the housing; and
a plurality of first terminal connectors connected to the cover and each disposed partially in or adjacent to two terminal channels of the plurality of terminal channels to electrically connect a respective two electrical terminals of the plurality of electrical terminals.

2. The electrical connector of claim 1, wherein the plurality of terminal channels extend from a first end of the housing to a second end of the housing such that the plurality of terminal channels are open at the first end and closed by the cover at the second end.

3. The electrical connector of claim 2, wherein the plurality of terminal channels are disposed in at least one row of terminal channels.

4. The electrical connector of claim 3, wherein the at least one row of terminal channels includes a first row of terminal channels and a second row of terminal channels;
the plurality of first terminal connectors includes a first set of first terminal connectors configured to electrically connect adjacent electrical terminals of the plurality of electrical terminals disposed in the first row of terminal channels;
the plurality of first terminal connectors include a second set of first terminal connectors configured to electrically connect adjacent electrical terminals of the plurality of electrical terminals disposed in the second row of terminal channels; and
the electrical connector further comprises a plurality of second terminal connectors each configured to electrically connect an electrical terminal of the plurality of electrical terminals in the first row of terminal channels with an electrical terminal of the plurality of electrical terminals in the second row of terminal channels.

5. The electrical connector of claim 4, wherein the plurality of second terminal connectors have a different configuration than the plurality of first terminal connectors.

6. The electrical connector of claim 5, wherein the plurality of first terminal connectors comprise spring contacts extending in opposite directions; and
the plurality of second terminal connectors comprise spring contacts extending in the same direction.

7. The electrical connector of claim 1, wherein the housing and the cover are electrically insulating, and the plurality of first terminal connectors are electrically conductive.

8. The electrical connector of claim 1, wherein a first terminal connector of the plurality of first terminal connectors comprises a base connected to the cover, a first spring arm extending from the base and disposed at least partially in a first terminal channel of the plurality of terminal channels, and a second spring arm extending from the base and disposed at least partially in a second terminal channel of the plurality of terminal channels; and
wherein the base, the first spring arm, and the second spring arm are disposed in a U-shaped configuration.

9. The electrical connector of claim 8, wherein the cover is in contact with a first side of the base, a second side of the base, an inner surface of the first spring arm, and an inner surface of the second spring arm.

10. The electrical connector of claim 9, wherein the cover is overmolded on the plurality of terminal connectors.

11. The electrical connector of claim 1, wherein the cover comprises a plurality of alignment protrusions extending into the plurality of terminal channels and configured to engage the plurality of electrical terminals.

12. The electrical connector of claim 11, wherein the plurality of alignment protrusions include blade configurations configured to extend into respective electrical terminals of the plurality of electrical terminals.

13. The electrical connector of claim 11, wherein the plurality of alignment protrusions each comprise a pair of slots configured to receive a portion of two electrical terminals of the plurality of electrical terminals.

14. The electrical connector of claim 1, wherein the plurality of terminal channels comprise twelve terminal channels;
the plurality of terminal connectors are configured to provide eight different splice configurations; and
the plurality of terminal connectors are disposed in the same configuration with each of the eight splice configurations.

15. The electrical connector of claim 14, wherein the eight different splice configurations comprise:
(i) a single splice for electrically connecting up to twelve electrical terminals of the plurality of electrical terminals;
(ii) one splice for electrically connecting two electrical terminals of the plurality of electrical terminals, and one splice for electrically connecting up to eight electrical terminals of the plurality of electrical terminals;
(iii) one splice for electrically connecting three electrical terminals of the plurality of electrical terminals, and one splice for electrically connecting up to seven electrical terminals of the plurality of electrical terminals;
(iv) one splice for electrically connecting four electrical terminals of the plurality of electrical terminals, and one splice for electrically connecting up to six electrical terminals of the plurality of electrical terminals;
(v) one splice for electrically connecting five electrical terminals of the plurality of electrical terminals, and one splice for electrically connecting up to five electrical terminals of the plurality of electrical terminals;
(vi) one splice for electrically connecting two electrical terminals of the plurality of electrical terminals, one splice for electrically connecting up to three electrical terminals of the plurality of electrical terminals, and one splice for electrically connecting four electrical terminals of the plurality of electrical terminals;
(vii) three splices, each for electrically connecting up to three electrical terminals of the plurality of electrical terminals; and
(viii) four splices, each for electrically connecting two electrical terminals of the plurality of electrical terminals.

16. An electrical assembly, comprising:
the electrical connector of claim 1;
the plurality of electrical terminals; and
a plurality of wires each connected to a respective electrical terminal of the plurality of electrical terminals.

17. The electrical assembly of claim 16, wherein the plurality of electrical terminals are disposed in the same orientation such that the plurality of wires extend out of the housing in the same direction.

18. The electrical assembly of claim 16, wherein the plurality of electrical terminals include a first set of electrical terminals electrically connected via the plurality of terminal connectors and a second set of electrical terminals electrically connected via the plurality of terminal connectors.

19. The electrical assembly of claim 18, wherein the first set of electrical terminals includes at least three electrical terminals and less than or equal to eight electrical terminals.

20. The electrical assembly of claim 16, wherein the electrical connector is a first electrical connector; and
the electrical assembly further comprises a second electrical connector releasably coupled with the first electrical connector in a stacked configuration.
